(19) United States
(12) Patent Application Publication
(10) Pub. No.: US 2012/0294540 A1
(43) Pub. Date: Nov. 22, 2012

(54) RANK ORDER-BASED IMAGE CLUSTERING

(75) Inventors: Jian Sun, Beijing (CN); Fang Wen, Beijing (CN); Chunhui Zhu, Beijing (CN)

(73) Assignee: MICROSOFT CORPORATION, Redmond, WA (US)

(21) Appl. No.: 13/109,868

(22) Filed: May 17, 2011

(51) Int. Cl. G06K 9/62

(52) U.S. Cl. 382/225

(57) ABSTRACT

Rank ordered-based object image clustering may facilitate robust clustering of digital images. The rank order-based clustering of object images may include defining asymmetric distances between each object image and one or more other object images in a set of multiple object images using generated ordered lists. The rank order-based clustering may further include obtaining a rank order distance for each pairing of object images by normalizing the asymmetric distances of corresponding object images. The multiple object images are further clustered into object image clusters based on the rank order distances and adaptive absolute distance.

### BACKGROUND

The proliferation of electronic devices that are capable of taking digital photographs has resulted in a tremendous growth of online photo posting and sharing. Often, users desire to sort, categorize, and annotate these digital photographs prior to posting or sharing them online. For example, a user may desire to sort the digital photographs so that digital photographs of different people are sorted into respective groups. Such sorting may enable the user to subsequently annotate the digital photographs in each group with descriptions or comments related to the person captured in the group. In other instances, such sorting may enable the user to email a particular group of digital photographs to the person portrayed in the group.

### SUMMARY

Described herein are techniques for clustering objects such as human faces that are captured in digital photographs using a rank order-based image clustering algorithm. The rank order-based image clustering algorithm may cluster the object images by measuring the dissimilarity distance between different neighborhoods of object images rather than absolute image distances between different object images. The use of neighborhood dissimilarity information rather than the absolute image distances may make the rank order-based object clustering techniques described herein less susceptible to variations in the distribution of objects, e.g., faces, that are captured in the digital photographs. Further, the rank-order based image clustering techniques may be more robust against variations in illumination, poses, expressions of the faces, as well as noise caused by random background objects, e.g., background faces, that are captured in the digital photographs.

In at least one embodiment, the rank order-based clustering of object images may include defining asymmetric distances between each object image and one or more other object images in a set of multiple object images using generated ordered lists. The rank order-based clustering may further include obtaining an image rank order distance for each pairing of object images by normalizing the asymmetric distances of corresponding object images. The multiple object images are further clustered into object image clusters based on the image rank order distances.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram that illustrates an example scheme that implements rank ordered-based clustering of object images.

FIG. 2 is a block diagram that illustrates selected components of an electronic device that implements rank order-based clustering of object images.

FIG. 3 is a flow diagram that illustrates an example process to implement rank order-based clustering of object images.

FIG. 4 is a flow diagram that illustrates an example iterative process to merge sub-clusters of object images into clusters.

### DETAILED DESCRIPTION

The embodiments described herein pertain to techniques for clustering objects images such as human faces that are captured in digital photographs using a rank order-based cluster engine. The rank order-based cluster engine may cluster the object images by measuring the dissimilarity distance between different neighborhoods of object images rather than the absolute image distances between different object images. In one example, faces that are captured in a set of object images may be distributed unevenly, e.g., certain faces may appear more frequently in the set of object images than other faces. Further, depending on the angle, distance, or angle of view at which the set of object images are captured, the appearances of the faces in the object images may vary from image to image. However, the use of neighborhood dissimilarity information by the rank order-based object image clustering techniques may enable the techniques to be less susceptible to variations in the distribution of the faces that are captured in the object images.

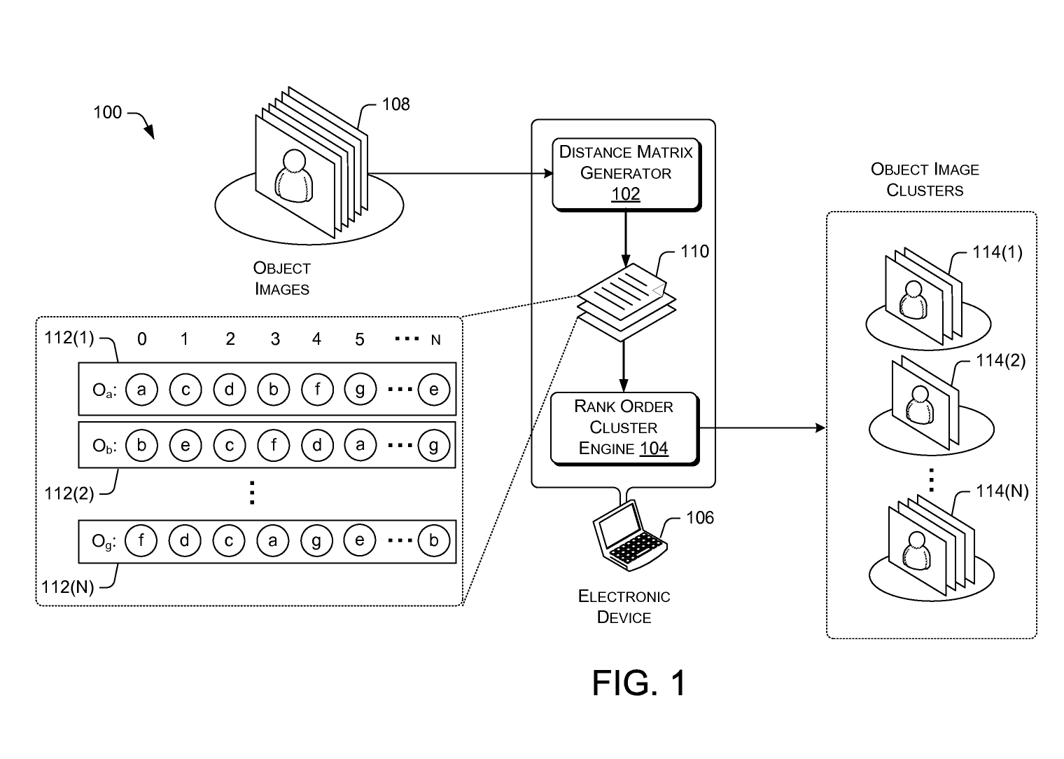

Moreover, since users generally take photographic images of faces in different environments rather than in a studio setting, variations in illumination, pose, expression, and noise caused by the appearance of other faces in the background may be common. However, by leveraging the use of neighborhood dissimilarity information rather than absolute image distances between difference object images that depict faces, the rank order-based image clustering techniques may be more robust against such variations. Various examples of techniques for implementing rank ordered-based clustering of object images in accordance with the embodiments are described below with reference to FIGS. 1-4.

### Example Scheme

FIG. 1 is a block diagram that illustrates an example scheme 100 that implements rank ordered-based clustering of object images. The example scheme 100 may be implemented by a distance matrix generator 102 and a rank order cluster engine 104 that are operating on an electronic device 106. The distance matrix generator 102 may generate a distance matrix 110 that includes an ordered list for the object images 108. In other words, given a particular object image 108, the distance matrix generator 102 may numerically order the other object images 108 according to their similarity to the particular object image 108 in an ordered list. In various embodiments, the degree of similarity between any two different object images 108 may be expressed by an absolute image distance that represents a degree of similarity. The absolute image distance may be derived with the use of various image recognition and comparison techniques. For the purpose of illustration, these embodiments are described below in the context of object images 108 that depict faces. However, it will be appreciated that the example scheme 100 may be implemented to cluster other object images that depict other objects in additional embodiments.

For example, as shown in FIG. 1, an ordered list 112(1) for a particular object image “a” that depicts a particular face may include object images “a”, “c”, “d”, “b”, “f”, “g”, and “e” that depict other faces. In this example, object image “a” is in the “0” numerical position in the ordered list 112 because object image “a” is an exact match to itself. Further, object image “c” may depict a face that resembles the face depicted by object image “a” more than any other faces in the other object images 108 (i.e., object image “c” may have the shortest absolute image distance to object image “a”). As a result, the object image “c” may occupy the numerical position “1” in the ordered list 112(1). Likewise, object image “d” may depict a face that is less similar to the face in the object image “a” than the face in the object image “c”. However, the face depicted in object image “d” may resemble the face in object image “a” more than any other faces in the other object images 108 (i.e., the object image “d” may have the second shortest absolute image distance). As a result, the object image “d” may occupy the numerical position 2 in the ordered list 112. The listing based on similarity may repeat so on and so forth with respect to the other object images “b”, “f”, and “e” that are listed in the ordered list 112(1).

Similarly, the distance matrix generator 102 may generate an ordered list 112(2) for the face depicted in the object image “b” in the same manner. In other words, the ordered list 112(2) may includes object images “b”, “e”, “c”, “f”, “d”, “a”, and “g” that are ordered in accordance with decreasing similarity between the face depicted in each of the object images and the face depicted in object image “b”. Further, the distance matrix generator 102 may also generate an ordered listed 112(N) for the face depicted in the object image “f” in the same manner, the ordered list 112(N) includes the object images “f”, “d”, “c”, “a”, “g”, “e”, and “b” ordered in accordance with decreasing similarity between the face depicted in each of the object images and the face depicted in object image “f”. Thus, the distance matrix generation 102 may generate such ordered lists until an ordered list is generated for each object image in the object images 108. In this way, a “n×n” distance matrix 110 may be formed from the ranked ordered lists 112(1)-112(N) by the distance generator 102, in which each numerical position in the ordered lists is a vertex in the distance matrix 110. In other embodiments, the distance matrix 110 may be formed from any number of other multiple ordered lists that are generated for different sets of object images.

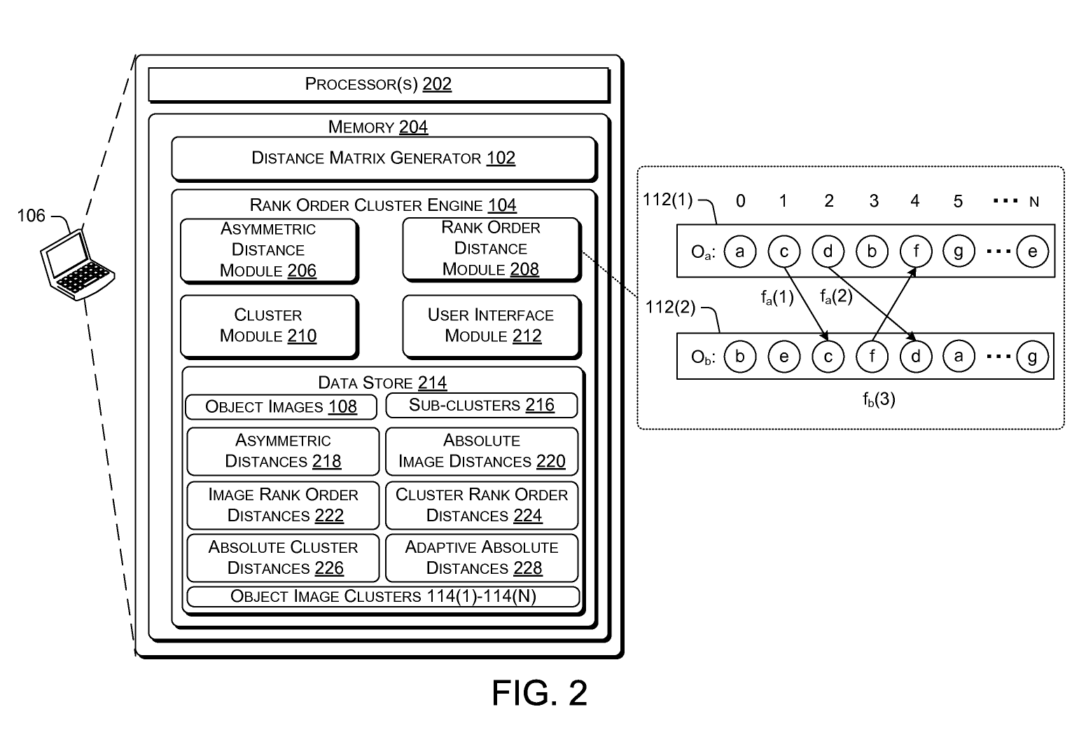

Subsequently, the rank order cluster engine 104 may use the distance matrix 110 to cluster the object images 108 into object image clusters 114(1)-114(N). In various embodiments, as further described with respect to FIG. 2, the rank order cluster engine 104 may perform such clustering by generating asymmetric distances for the ordered lists in the distance matrix 110, such as the ordered lists 112(1)-112(N). The rank order cluster engine 104 may then normalize the asymmetric distances into image rank order distances. Subsequently, the rank order cluster engine 104 may use the image rank order distances to group object images 108 into object image clusters 114. In some embodiments, such clusters may be object image clusters 114(1), 114(2), . . . 114(N). However, in other embodiments, at least two of such clusters may be further merged by the rank order cluster engine 104 before the resultant clusters become the object image clusters 114(1)-114(N).

Thus, by using the image rank order distances, the rank order cluster engine 104 may in some instances adapt to non-uniform distribution of different faces in the object images 108 during clustering of the object images 108. Similarly, with the use of rank order distances, the rank order cluster engine 104 may also in some instances cope with variations in the appearances of the faces captured in the object images 108.

### Example Electronic Device Components

FIG. 2 is a block diagram that illustrates selected components of an electronic device that implements rank order-based image clustering. In various embodiments, the electronic device 106 may be a general purpose computer, such as a desktop computer, a tablet computer, a laptop computer, a server, and so forth. However, in other embodiments, the electronic device 106 may be one of a smart phone, a game console, a personal digital assistant (PDA), and so forth.

The electronic device 106 may include one or more processors 202, memory 204, and/or user controls that enable a user to interact with the electronic device. The memory 204 may be implemented using computer readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

The electronic device 106 may have network capabilities. For example, the electronic device 106 may exchange data with other electronic devices (e.g., laptops computers, servers, etc.) via one or more networks, such as the Internet. In some embodiments, the electronic device 106 may be substituted with a plurality of networked servers, such as servers in a cloud computing network.

The one or more processors 202 and the memory 204 of the electronic device 106 may implement the distance matrix generator 102 and the rank order cluster engine 104. The rank order cluster engine 104 may include an asymmetric distance module 206, a rank order distance module 208, a cluster module 210, a user interface module 212, and a data store 214. The modules in the rank order cluster engine 104 may include routines, programs instructions, objects, and/or data structures that perform particular tasks or implement particular abstract data types.

The asymmetric distance module 206 may determine the asymmetric distances between each object image and every other object image of the object images 108. In some embodiments, each of the object images 108 may depict a corresponding human face. For the sake of clarity, the operations performed by the asymmetric distance module 206 is described below with respect to the ordered list 112(1) of the object image a and the ordered list 112(2) of the object image b. However, it will be appreciated that the operations performed by the asymmetric distance module 206 are applicable to distance matrices that contain any plurality of ordered lists.

Thus, in an example with two object images a and b, which may depict corresponding faces, and a distance matrix that includes their respectively ordered lists Oₐ 112(1) and O_{b} 112(2), the asymmetric distance module 206 may define the asymmetric distance between the object images a and b as shown in Equation (1):

D(a,b)=Σᵢ₌₀^{O}^{ₐ}^{(b)}O_{b}(fₐ(i)) D(b,a)=Σᵢ₌₀^{O}^{_{b}}^{(a)}Oₐ(f_{b}(i)) (1)

in which function fₐ(i) may return the i^{th} object image in the ordered list Oₐ of a, Oₐ(b) may return the ranking order of b in Oₐ. Likewise, f_{b}(i) returns i^{th} object image in the ordered list O_{b} of b, and O_{b}(a) may return the ranking order of a in O_{b}. The asymmetric distance D(a, b) may be the sum of the ranking orders of the top Oₐ(b) object images in O_{b} from Oₐ. The asymmetric distance D(a, b) may measure whether the nearest image object neighbors of object image a are also object image b's nearest neighbors. For example, given the particular ordered lists Oₐ 112(1) and O_{b} 112(2) as illustrated in FIG. 2, the asymmetric distance module 206 may calculate the asymmetric distance D(a, b) as follows:

D(a,b)=O_{b}(a)+O_{b}(fₐ(1))+O_{b}(fₐ(2))+O_{b}(b)=5+2+4+0=11.

Conversely, the asymmetric distance D(b, a) may be the sum of the ranking orders of the top O_{b}(a) object images in Oₐ from O_{b}. The asymmetric distance D(b, a) may measure whether the nearest image object neighbors of object image b are also object image a's nearest neighbors.

Subsequently, the rank order distance module 208 may normalize the asymmetric distance between each object image and every other object image in the object images 108. Once again, for the sake of clarity, the operations performed by the rank order distance module 208 are described below with respect to the asymmetric distances of object image a and object image b. However, it will be appreciated that the operations performed by the rank order distance module 208 are applicable to the asymmetric distances of any plurality of ordered lists.

Thus, continuing with the example described above with the object image a and b, which may depict corresponding faces, the rank order distance module 208 may normalize the asymmetric distances D(a, b) and D(b, a) between the object images a and b to make the distances symmetric, and obtain an image rank order distance as shown in Equations (2):

$${D}^{R} ( a , b ) = \frac{D ( a , b ) + D ( b , a )}{min ( {O}_{a} ( b ) , {O}_{b} ( a ) )} \qquad ( 2 )$$

In this way, D^{R}(a, b) may contain integrated information from D(a, b) and D(b, a), which provides stronger evidence than absolute image distance of whether two object images have a truly close relationship.

In other words, since an image rank order distance is derived from information related to a neighborhood of object images, the image rank order distance may be more reliable as a measurement of similarity between two object images than an absolute image distance between the object images. Therefore, an image rank order distance is less susceptible to a variation in the distribution of different objects, e.g., faces, in the object images 108. The image rank order distance may also be more robust against the existence of noise and outliers (e.g., other faces in a backdrop, etc.) in the object images 108.

The cluster module 210 may cluster the object images 108 according to the image rank order distances of the object images 108. In various embodiments, the cluster module 210 may merge object images 108 with image rank order distances that are smaller than a predetermined merge distance threshold value into a cluster. However, in many instances, this merging by the cluster module 210 may produce multiple “sub-cluster” of object images 108 for a particular object, e.g., a face, as depicted in the object images 108. For example, in the context of object images that are facial images, this sub-clustering effect may be produced by variations in illumination, pose, expression, and other factors that affect the appearances of the faces depicted in the object images 108. As a result, multiple sub-clusters of object images that depict faces of the same person may be produced, and while the object images in each of the sub-clusters may be highly related to each other, each of the multiple sub-clusters may be only marginally related to each other. For example, such sub-clustering may be produced by different illumination conditions that existed when the object images 108, e.g., facial images of the same person, in the two sub-clusters were captured.

Accordingly, a particular solution is to extend the application of rank order distance from measuring dissimilarity between any two object images to any two sub-clusters of object images, and merge each pair of sub-clusters with a rank order distance that is smaller than a predetermined cluster distance threshold value. In such a solution, an absolute cluster distance may be defined as a minimum pair-wise distance for any two sub-clusters as shown in Equation (3):

$$D ( {C}_{1} , {C}_{2} ) = {min}_{∀ {x}_{1} ∈ {C}_{1} , {x}_{2} ∈ {C}_{2}} d ( {x}_{1} , {x}_{2} ) \qquad ( 3 )$$

where C₁, C₂ are the two sub-clusters, and x₁, x₂ are object images, e.g., facial images, in C₁, C₂. Once such an absolute cluster distance is defined, a cluster rank order distance may be derived for the two sub-clusters in a manner similar to as described in equation (2). However, when the number of sub-clusters is small, the derived cluster rank order distance may become meaningless. To counter this problem, the cluster rank order distance for each pair of sub-clusters may be combined with their absolute cluster distance to produce an adaptive absolute distance for determining the merge of sub-clusters.

Thus, in some embodiments, the cluster module 210 may use adaptive absolute distances to merge the sub-clusters in an iterative manner until the distinctive object image clusters 114(1)-114(N) of the object images 108 are produced. The adaptive absolute distance between any two sub-clusters of object images may be calculated as shown in Equation (4):

$$\begin{matrix}D ( {C}_{1} , {C}_{2} , k ) = {min}_{∀ {x}_{1} ∈ {C}_{1} , {x}_{2} ∈ {C}_{2}} \frac{1}{φ ( {C}_{1} , {C}_{2} , k )} d ( {x}_{1} , {x}_{2} ) φ ( {C}_{1} , {C}_{2} , k ) \\ = \frac{1}{\vert {C}_{1} \vert + \vert {C}_{2} \vert} {\sum }_{a ∈ {C}_{1} ⋃ {C}_{2}} {\sum }_{j = 1}^{k} \frac{1}{k} d ( {x}_{a} ( j ) , a )\end{matrix} \qquad ( 4 )$$

in which φ(C₁, C₂, k) may be an average distance of all the object images, e.g., facial images, in the two sub-clusters to their most similar k neighboring object images, for which k indicates a predefined number of object images. Thus, D(C₁, C₂, k) may represent an absolute cluster distance between the sub-clusters that is scaled according to statistical information on the sub-cluster neighborhoods of the sub-clusters. In this way, the cluster module 210 may evaluate the absolute cluster distances from dense or spare groups of sub-clusters with uniform criteria.

As a result, given that the cluster module 210 encounters two sub-clusters C₁ and C₂, a neighborhood size k and a rank order threshold t at a particular iterative step, the cluster module 210 may calculate an adaptive absolute distance for the two sub-clusters, and then merge the two sub-clusters when their cluster rank order distance D^{R}(C₁, C₂)<t and the adaptive absolute distance D (C₁, C₂, k)<1. The rank order threshold value t may be any value that produces the merging of the sub-clusters of object images 108 depicting the same object, e.g., the same face, without merging clusters of object images 108 that depict different objects, e.g., different faces. In some embodiments, this rank order threshold value t may be defined manually through experimentation. After each iterative step, the cluster module 210 may update the cluster rank order distances of the resultant sub-clusters for the next iterative step. In some embodiments, the cluster module 210 may perform this update by recalculating the cluster rank order distances for the resultant sub-clusters.

The cluster module 210 may iteratively perform such steps until merging of the sub-clusters is complete (no more merging) or a predefined maximum iteration limit has been reached, or whichever occurs sooner. The predefined maximum iteration limit may ensure that the clustering of the object images 108 is completed in a reasonable amount of time. In some embodiments, any un-clustered object images remaining after the iterations have terminated may be placed into an additional cluster. In this way, the cluster module 210 may iteratively produce the object image clusters 114(1)-114(N).

Thus, the rank order-based clustering algorithm implemented by the asymmetric distance module 206, the rank order distance module 208, and the cluster module 210 in at least one embodiment may be expressed as shown in Algorithm 1:

Algorithm 1

Input:

Distance matrix d_{n×n}, neighborhood size k and kₐ,
RankOrder threshold t, maximum iteration iterₘₐₓ.

Output:

Clustering result {C₁, C₂,..., Cₗ, Cₗ₊₁}.
Initialize clusters {C₁, C₂,..., Cₙ}. D ← d_{n×n}, iter ← 0.
while iter < iterₘₐₓ do

For i = 1,..., l, compute D^{R}(Cᵢ,Cⱼ) as in (2) for each Cⱼ in Cᵢ's

k top neighbor list, and D (Cᵢ, Cⱼ, kₐ) as in (4).

Merge Cᵢ and Cⱼ, if D (Cᵢ, Cⱼ, kₐ) < 1 and D^{R} (Cᵢ, Cⱼ) < t.
Update {C₁, C₂,..., Cₗ} and matrix D in (3). iter ← iter + 1.
Stop iteration if no merge happens.

end while

Put un-clustered faces in Cₗ₊₁. {C₁, C₂,..., Cₗ, Cₗ₊₁}.

Return {C₁, C₂,..., Cₗ, Cₗ₊₁}.

In at least one embodiment, the implementation of Algorithm 1 by the rank order cluster engine 104 may cluster object images 108 that depict faces in a bottom-up agglomerative manner to obtain face clusters {C₁, C₂, . . . , Cₗ} and put all the un-clustered faces in Cₗ₊₁.

The user interface module 212 may enable a user to interact with the various modules on the electronic device 106 using a user interface. The user interface may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods.

In various embodiments, the user interface module 212 may enable a user to initiate, monitor, and review the results of the rank order-based face clustering. For example, the user interface module 212 may enable the user to select a set of object images, such as object images depicting faces, for the rank order cluster engine 104 to sort into clusters. In turn, the rank order cluster engine 104 may use the user interface module 212 to provide status displays or graphics that indicate the progress of the rank order cluster engine 104. Moreover, the user interface module 212, in concert with the rank order cluster engine 104, may also enable the user to access and view the object images in each of the image clusters, such as the object image clusters 114(1)-114(N). In additional embodiments, the user interface module 212 may also enable the user to adjust the various threshold values that are used during the operations of the rank order cluster engine 104, such as the rank order threshold value t, the merger distance threshold value, and/or the cluster distance threshold value described above.

The data store 214 may store the object images 108, both in un-clustered and clustered form, such as in sub-clusters 216 and/or image clusters 114(1)-114(N). In various embodiments, the object images 108 may be stored in uncompressed (i.e., raw), lossless compression, or lossy compression formats. The data store may further store the distance matrices and ordered listed that are derived from object images, such as the object images 108, as well as associated asymmetric distances 218, absolute image distances 220, image rank order distances 222, cluster rank order distances 224, absolute cluster distances 226, adaptive absolute distances 228, and so forth. In various embodiments, an absolute image distance that measures similarity between any two objects (e.g., faces) depicted in the object images 108 may be derived using various classification schemes (explicitly and/or implicitly trained) and/or machines (e.g., support vector machines, neural networks, expert systems, Bayesian belief networks, fuzzy logic, data fusion engine, and/or the like. Accordingly, the data store 214 may further store other intermediate products or values that are generated or used by the distance matrix generator 102 or the rank order cluster engine 104.

In some embodiments, the distance matrix generator 102 and the rank order cluster engine 104 may be integral parts of a photo editing or online media sharing application. Such an application may enable the user to further annotate, comment, edit, distribute, or otherwise manipulate the object images 108 that are clustered by the rank order cluster engine 104.

While the operations of the distance matrix generator 102 and the rank order cluster engine 104 is described above with respect to clustering of object images 108 that depict faces, the rank order cluster engine 104 may also be adapted to cluster other objects that are captured in object images (e.g., images of animals, plants, man-made objects, etc.) in other embodiments.

### Example Processes

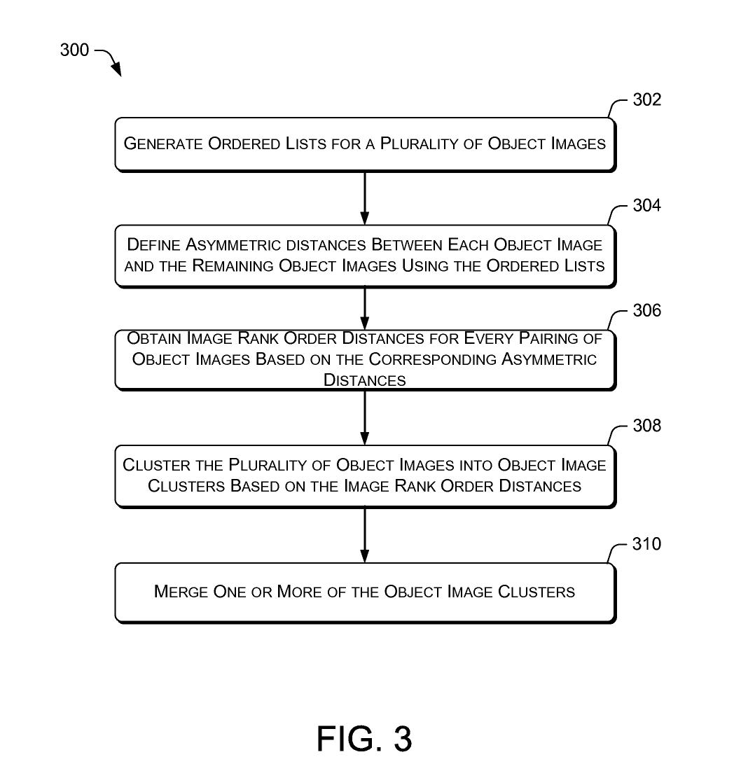

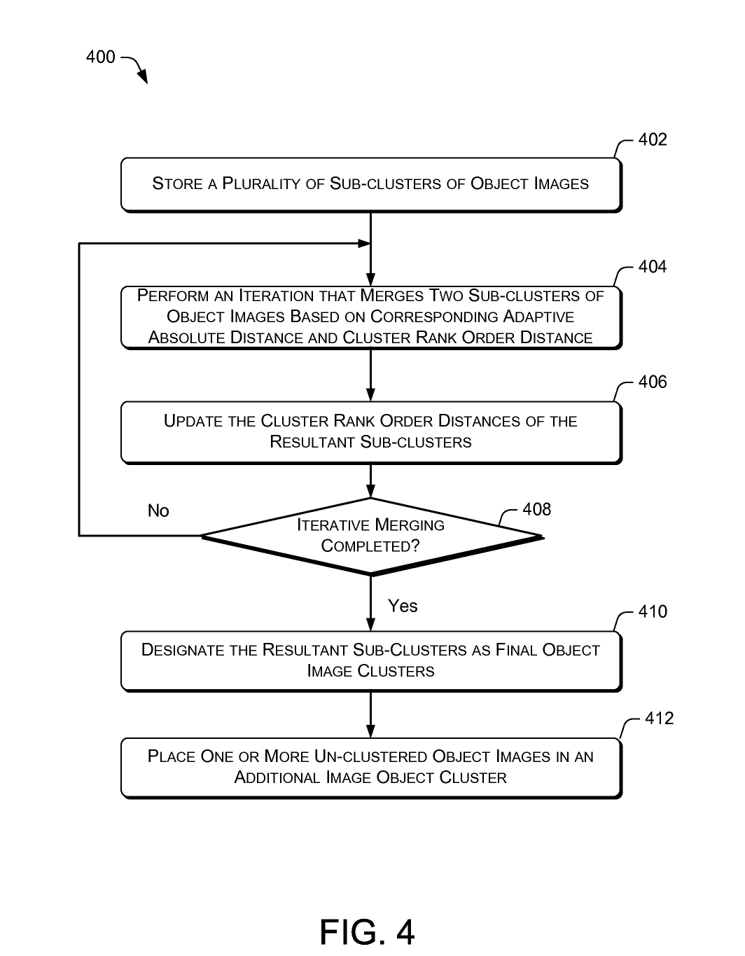

FIGS. 3-4 describe various example processes for implementing rank-order based clustering of object images. The order in which the operations are described in each example process is not intended to be construed as a limitation, and any number of the described blocks can be combined in any order and/or in parallel to implement each process. Moreover, the blocks in each of the FIGS. 3-4 may be operations that can be implemented in hardware, software, and a combination thereof. In the context of software, the blocks represent computer-executable instructions that, when executed by one or more processors, cause one or more processors to perform the recited operations. Generally, computer-executable instructions include routines, programs, objects, components, data structures, and so forth that cause the particular functions to be performed or particular abstract data types to be implemented.

FIG. 3 is a flow diagram that illustrates an example process 300 to implement rank order-based clustering of object images. At block 302, the distance matrix generator 102 may generate a corresponding ordered list for each of a plurality of object images 108. In various embodiments, an ordered list for a particular object image may numerically rank the other object images of the object images 108 according to their absolute image distances, such as the absolute image distance 220, to the particular object image. Each of the absolute image distances may represent a degree of similarity between a corresponding object image and the particular object image, with an increasing absolute image distance representing increasing image dissimilarity, and vice versa. The object images listed in each ordered list may rank the object images according to increasing absolute image distance. The plurality of ordered lists may form a distance matrix 110.

At block 304, the asymmetric distance module 206 may define asymmetric distances, such as the asymmetric distances 218, between each object image and the remaining object images of the plurality of object images 108 using the ordered lists in the distance matrix 110. The asymmetric distance module 206 may be part of the rank order cluster engine 104. For example, given ordered lists for two object images a and b, the asymmetric distance D(a, b) may be the sum of the ranking orders of the top Oₐ(b) objects in O_{b} from Oₐ. The asymmetric distance D(a, b) may measure whether the nearest object image neighbors of object image a are also object image b's nearest neighbors. Conversely, the asymmetric distance D(b, a) may be the sum of the ranking orders of the top O_{b} (a) object images in Oₐ from O_{b}. The asymmetric distance D(b, a) may measure whether the nearest object image neighbors of object image b are also object image a's nearest neighbors.

At block 306, the rank order distance module 208 may obtain a corresponding image rank order distance, such as the image rank order distance 222, for every possible pairings of object images in the plurality of object images 108 based on the corresponding asymmetric distances. The rank order distance module 208 may be part of the rank order cluster engine 104. In various embodiments, the rank order distance module 208 may normalize the asymmetric distances for a pair of object images to derive a corresponding image rank order distance. For example, given two object images a and b, the rank order distance module 208 may normalize their asymmetric distances D(a, b) and D(b, a) to obtain a corresponding image rank order distance.

At block 308, the cluster module 210 included in the rank order cluster engine 104 may cluster the plurality of object images into object image clusters based on the image rank order distances. In various embodiments, the cluster module 210 may merge object images 108 with image rank order distances that are smaller than a predetermined merge distance threshold value into a cluster.

At block 310, the cluster module 210 may further merge one or more object image clusters together. For example, the clusters that are obtained based on the image rank order distances may include multiple sub-clusters of object images that depict the same object, such as the same face. This sub-clustering effect may be produced by variations in illumination, pose, expression, and other factors that affect the appearances of the faces depicted in the object images 108. In various embodiments, the cluster module 210 may use adaptive absolute distances, such as the adaptive absolute distance 228, to merge the sub-clusters in an iterative manner until the distinctive object image clusters 114(1)-114(N) of the object images 108 are produced.

FIG. 4 is a flow diagram that illustrates an example iterative process 400 to merge sub-clusters of object images into clusters. The example iterative process 400 may further illustrate block 310 of the example process 300. At block 402, a plurality of sub-clusters of object images may be stored into the data store 214 following initial clustering by the cluster module 210.

At block 404, the cluster module 210 may perform an iteration that calculates a corresponding adaptive absolute distance, and then merges two sub-clusters of object images based on the corresponding adaptive absolute distance and a corresponding cluster rank order distance. As described above, the cluster module 210 may merge the two sub-clusters when their cluster rank order distance D^{R} (C₁, C₂)<t and their adaptive absolute distance D(C₁, C₂, k)<1. In at least one embodiment, the rank order threshold value t may be any value that produces the merging of the sub-clusters of object images 108 depicting the same object (e.g., the same face) without merging clusters of object images 108 that depict different objects (e.g., different faces).

At block 406, the cluster module 210 may update the cluster rank order distances of the resultant sub-clusters that resulted from the merge of the two sub-clusters. In some embodiments, the cluster module 210 may perform this update by recalculating the cluster rank order distances for the resultant sub-clusters.

At decision block 408, the cluster module 210 may determine whether iterative merging of the sub-clusters has been completed. Iterative merging of the sub-clusters may be deemed complete when no more merging of the sub-clusters occurs or a predefined maximum number threshold of iterations has been reached, or whichever occurs sooner. Thus, if the cluster module 210 determines that the iterative merging of the sub-clusters is incomplete (“no” at decision block 408), the process 400 may loop back to block 404 so that an additional iteration may be performed by the cluster module 210.

However, if the cluster module 210 determines that the iteratively merging of the sub-clusters is completed (“yes” at decision block 408), then the process 400 may proceed to block 410. At block 410, the cluster module 210 may designate the resultant sub-clusters remaining after the merging iterations as the final object image clusters of the object images 108. At block 412, the cluster module 210 may place one or more un-clustered object images 108 in an additional object image cluster.

The rank order-based clustering of object images described herein may be less susceptible to variations in the distribution of the objects, e.g., faces that are captured in object images. Further, in the context of object images that depict facial images, the rank-order based clustering techniques may be more robust against variations in illumination, poses, expressions of the faces depicted in the object images, as well as noise caused by random background faces that are captured in the object images.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

1. A computer-readable medium storing computer-executable instructions that, when executed, cause one or more processors to perform acts comprising:
defining asymmetric distances between each object image and one or more remaining object images of a plurality of object images using ordered lists generated for the plurality of object images;
obtaining an image rank order distance for each pairing of object images in the plurality of object images by normalizing the asymmetric distances of corresponding object images; and
clustering the plurality of object images into object image clusters based at least in part on image rank order distances.

2. The computer-readable medium of claim 1, further comprising instructions that, when executed, cause the one or more processors to perform an act of generating ordered lists for the plurality of object images, each ordered list being generated for a corresponding object image and ranking other object images of the plurality of object images according to similarity with the corresponding object image.

3. The computer-readable medium of claim 2, wherein similarity between two object images is measured by a corresponding absolute image distance.

4. The computer-readable medium of claim 1, further comprising instructions that, when executed, cause the one or more processors to perform an act of merging one or more of the object image clusters.

5. The computer-readable medium of claim 4, wherein the merging includes merging two object image clusters based on an adaptive absolute distance that is scaled according to statistical information from predefined image cluster neighborhoods of the two object image clusters.

6. The computer-readable medium of claim 5, wherein the adaptive absolute distance is defined based at least in part on an average distance of the object images in two sub-clusters to a predefined number of their most similar neighboring object images.

7. The computer-readable medium of claim 4, wherein the merging includes performing a plurality of merging iterations, each merging iteration including:
merging two object image clusters of a plurality of image clusters when a corresponding adaptive absolute distance and a corresponding cluster rank order distance are less than respective threshold values; and
updating cluster rank order distances of resultant image clusters.

8. The computer-readable medium of claim 4, further comprising instructions that, when executed, cause the one or more processors to perform an act of placing one or more un-clustered images objects remaining after the merging in an additional object image cluster.

9. The computer-readable medium of claim 1, wherein the ordered lists are organized into a distance matrix, and wherein the defining includes defining the asymmetric distances based on the ordered lists in the distance matrix.

10. The computer-readable medium of claim 1, wherein a first asymmetric distance between a pair of object images is defined as D(a, b)=Σᵢ₌₀^{O}^{ₐ}^{(b)} O_{b}(fₐ(i)), and a second symmetric distance between the pair of object image is defined as D(b, a)=Σᵢ₌₀^{O}^{_{b}}^{(a)} Oₐ(f_{b}(i)), wherein a is a first object image, and b is a second object image, Oₐ represents an ordered list for the first object image, and O_{b} represents an ordered list for the second image, and wherein function fₐ(i) returns the i^{th} object image in the ordered list of the first object image, Oₐ(b) returns the ranking order of b in Oₐ, and f_{b}(i) returns i^{th} object in the ordered list of the second object image, and O_{b} (a) returns the ranking order of a in O_{b}.

11. The computer-readable medium of claim 10, wherein a particular image ranking order distance for a first object image and a second object image is defined as:
$${D}^{R} ( a , b ) = \frac{D ( a , b ) + D ( b , a )}{min ( {O}_{a} ( b ) , {O}_{b} ( a ) )}$$
wherein D^{R}(a, b) represents the particular image ranking order distance.

12. The computer-readable medium of claim 1, wherein each of the plurality of object images includes a facial image.

13. A computer-implemented method, comprising:
generating ordered lists for a plurality of object images, each ordered list being generated for a corresponding object image and ranking other object images of the plurality of object images according to similarity with the corresponding object image;
defining asymmetric distances between each object image and one or more remaining object images of the plurality of object images using the ordered lists;
obtaining an image rank order distance for each pairing of object images in the plurality of object images by normalizing the asymmetric distances of corresponding object images;
clustering the plurality of object images into sub-clusters based at least in part on image rank order distances; and
merging one or more of the sub-clusters to form object image clusters.

14. The computer-implemented method of claim 13, further comprising placing one or more un-clustered images objects remaining after the merging in an additional object image cluster.

15. The computer-implemented method of claim 13, wherein the merging includes merging two object image clusters based on an adaptive absolute distance that is scaled according to statistical information from predefined image cluster neighborhoods of the two object image clusters.

16. The computer-implemented method of claim 15, wherein the adaptive absolute distance is defined based at least in part on an average distance of the object images in two sub-clusters to a predefined number of their most similar neighboring object images and scaled according to statistical information from predefined image cluster neighborhoods of the two object image clusters.

17. The computer-implemented method of claim 13, wherein the merging includes performing a plurality of merging iterations, each merging iteration including:
merging two object image clusters of a plurality of image clusters when a corresponding adaptive absolute distance and a corresponding cluster rank order distance are less than respective threshold values; and
updating cluster rank order distances of resultant image clusters.

18. A computing device, comprising:
one or more processors; and
a memory that includes a plurality of computer-executable components, the plurality of computer-executable components comprising:
a distance matrix generator that generates a distance matrix that includes ordered lists for a plurality of object images, each ordered list being generated for a corresponding object image and ranking other object images of the plurality of object images according to similarity with the corresponding object image; and
a rank order cluster engine that clusters the plurality of object images based at least in part on image rank order distances derived from the ordered lists.

19. The computing device of claim 18, wherein the ranking order cluster engine derives the image rank order distances by:
defining asymmetric distances between each object image and one or more remaining object images of a plurality of object images using the ordered lists; and
obtaining an image rank order distance for each pairing of object images in the plurality of object images by normalizing the asymmetric distances of corresponding object images.

20. The computing device of claim 18, wherein the rank order cluster engine further merges one or more of the object image clusters.
